(19) United States
(12) Patent Application Publication
(10) Pub. No.: US 2024/0306107 A1
(43) Pub. Date: Sep. 12, 2024

(54) INFORMATION PROCESSING METHOD AND APPARATUS, AND DEVICE AND STORAGE MEDIUM

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN); Xinlei YU, Dongguan (CN)

(21) Appl. No.: 18/663,274

(22) Filed: May 14, 2024

Related U.S. Application Data
(63) Continuation of application No. PCT/CN2022/070370, filed on Jan. 5, 2022.

(51) Int. Cl. H04W 56/00; H04W 76/30; H04W 84/06

(52) U.S. Cl. CPC H04W 56/0045; H04W 56/0015; H04W 76/30; H04W 84/06

(57) ABSTRACT

Disclosed are an information processing method and apparatus, and a device and a storage medium. The method includes: when the valid time of satellite assistance information expires, executing an operation related to an uplink transmission resource and/or a timing advance (TA).

### CROSS-REFERENCE TO RELATED APPLICATION

This application is a continuation of International Patent Application No. PCT/CN2022/070370 filed on Jan. 5, 2022, the disclosure of which is hereby incorporated by reference in its entirety.

### TECHNICAL FIELD

The disclosure relates to the field of communication, and in particular, to a method and apparatus for information processing, device, and storage medium.

### BACKGROUND

In order to describe effectiveness of satellite assistance information in a non-terrestrial network (NTN) system, a valid time mechanism is introduced, and the duration of the valid time is defined for satellite assistance information.

After acquiring the satellite assistance information, when the valid time of the satellite assistance information expires, it is considered that the satellite assistance information acquired by the terminal so far is invalid. Then, before acquiring new satellite assistance information, the terminal will be in an uplink out-of-step state. The behavior of the terminal at such time needs to be defined.

### SUMMARY

Embodiments of the disclosure provide a method and apparatus for information processing, a device, and a storage medium. When satellite assistance information expires, the behavior of a terminal is defined to cause it execute an operation related to an uplink transmission resource and/or a timing advance (TA), so as to cause the terminal to determine the uplink transmission resource again or adjust the uplink TA. The technical solutions are as follows.

According to an aspect of the disclosure, there is provided a method for information processing, applied to a terminal. The method includes the following operation.

An operation related to an uplink transmission resource and/or a TA is executed when a valid time of satellite assistance information expires.

According to an aspect of the disclosure, there is provided an apparatus for information processing. The apparatus includes an execution module.

The execution module is configured to execute an operation related to an uplink transmission resource and/or a TA when a valid time of satellite assistance information expires.

According to an aspect of the disclosure, there is provided a computer device including a processor.

The processor is configured to execute an operation related to an uplink transmission resource and/or a TA when a valid time of satellite assistance information expires.

According to an aspect of the disclosure, there is provided a computer-readable storage medium having stored therein a computer program, which being executed by a processor to implement the method for information processing described above.

According to an aspect of the disclosure, there is provided a chip including a programmable logic circuit and/or program instructions for implementing the method for information processing described above when the chip is running.

According to an aspect of the disclosure, there is provided a computer program product or computer program, including computer instructions stored in a computer-readable storage medium, from which a processor reads and executes the computer instructions to implement the method for information processing described above.

Technical solutions provided in the embodiments of the disclosure include at least the following beneficial effects.

A method for information processing is provided, when the valid time of the satellite assistance information expires, the behavior of the terminal is defined to cause it execute the operation related to the uplink transmission resource and/or the TA, so as to cause the terminal to determine the uplink transmission resource again and/or adjust the uplink TA.

### BRIEF DESCRIPTION OF THE DRAWINGS

In order to illustrate the technical solutions in the embodiments of the disclosure more clearly, the accompanying drawings used in the description of the embodiments will be briefly described below. It is apparent that the accompanying drawings described below are only some embodiments of the disclosure, and other accompanying drawings can be further obtained from these accompanying drawings for those of ordinary skilled in the art without creative effort.

FIG. 1 is a network architecture diagram of a transparent load NTN provided in an exemplary embodiment of the disclosure.

FIG. 2 is a network architecture diagram of a regenerative load NTN provided in an exemplary embodiment of the disclosure.

FIG. 3 is a schematic diagram of time synchronization on the network device side provided in an exemplary embodiment of the disclosure.

FIG. 4 is a flowchart of a method for information processing provided in an exemplary embodiment of the disclosure.

FIG. 5 is a flowchart of a method for information processing provided in an exemplary embodiment of the disclosure.

FIG. 6 is a flowchart of a method for information processing provided in an exemplary embodiment of the disclosure.

FIG. 7 is a flowchart of a method for information processing provided in an exemplary embodiment of the disclosure.

FIG. 8 is a schematic diagram of an implementation of a method for information processing provided in an exemplary embodiment of the disclosure.

FIG. 9 is a flowchart of a method for information processing provided in an exemplary embodiment of the disclosure.

FIG. 10 is a schematic diagram of an implementation of a method for information processing provided in an exemplary embodiment of the disclosure.

FIG. 11 is a flowchart of a method for information processing provided in an exemplary embodiment of the disclosure.

FIG. 12 is a schematic diagram of an implementation of a method for information processing provided in an exemplary embodiment of the disclosure.

FIG. 13 is a structural diagram of an apparatus for information processing provided in an exemplary embodiment of the disclosure.

FIG. 14 is a schematic structural diagram of a communication device provided in an exemplary embodiment of the disclosure.

### DETAILED DESCRIPTION

In order to make the purposes, technical solutions, and advantages of the disclosure clearer, embodiments of the disclosure will be described in further detail below in conjunction with the accompanying drawings.

At present, the third generation partnership project (3GPP) is studying NTN technology, which generally provides communication services to ground users by means of satellite communication. Compared with terrestrial cellular network communication, satellite communication has many unique advantages. Firstly, satellite communication is not limited by the region of user. For example, general land communication cannot cover areas such as oceans, mountains, deserts, etc., where communication equipment cannot be set up or communication coverage not be done due to sparse population. For satellite communication, a satellite can cover a large ground, and the satellite can orbit around the earth, therefore every corner of the earth can be covered by satellite communication in theory. Secondly, satellite communication has great social value. Satellite communication can be covered at a lower cost in remote mountainous areas and poor and backward countries or regions, so that people in these areas can enjoy advanced voice communication and mobile Internet technology, which is conducive to narrowing the digital divide with developed regions and promoting regional development. Thirdly, satellite communication has a long distance, and the communication cost does not increase significantly with the increase of communication distance. Finally, satellite communication has a high stability and is not limited by natural disasters.

Communications satellites are divided into low-earth orbit (LEO) satellites, medium-earth orbit (MEO) satellites, geostationary earth orbit (GEO) satellites, high elliptical orbit (HEO) satellites and so on based on different orbital altitudes. At present, LEO and GEO are mainly studied.
1. LEO: the altitude range of LEO satellites is 500 km-1500 km, and the corresponding orbit period is about 1.5 hours-2 hours. The signal propagation delay of single-hop communication between users is generally less than 20 ms. The maximum satellite visual time is 20 minutes. The signal propagation distance is short, the link loss is less, and the transmission power requirement of the user terminal is not high.
2. GEO: geostationary earth orbit satellite with an orbit altitude of 35,786 km and a rotation period of 24 hours around the earth. The signal propagation delay of single-hop communication between users is generally 250 ms.

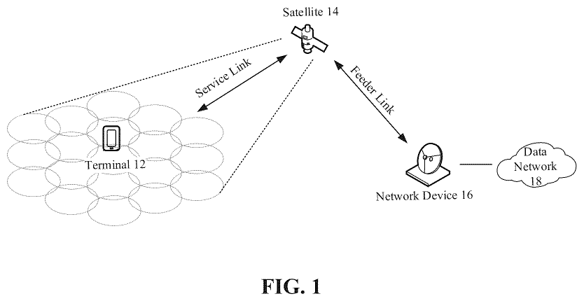

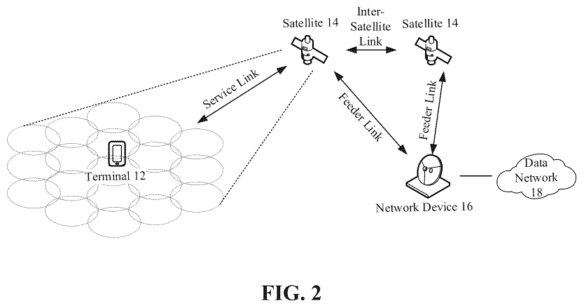

In order to ensure the coverage of satellite and improve the system capacity of the entire satellite communication system, satellite cover the ground with multiple beams, and a satellite can form dozens or even hundreds of beams to cover the ground. A satellite beam can cover the ground area with a diameter of tens to hundreds of kilometers. There are at least two NTN scenarios: a transparent load NTN, as shown in FIG. 1; and a regeneration load NTN, as shown in FIG. 2.

The NTN network consists of the following network elements.
one or more gateways: configured to connect satellite and ground public network.

Feeder link: for communication between the gateway and the satellite.

Service link: for communication between a terminal and the satellite.

Satellite: it can be divided into two types: a transparent load and a regenerative load from the functions it provides.

Transparent load: provides only functions of radio frequency filtering, frequency conversion and amplification. It provides only transparent forwarding of signals, and does not change the waveform signals it forwards.

Regenerative load: in addition to providing functions of radio frequency filtering, frequency conversion and amplification, it can also provide functions of demodulation/decoding, routing/conversion, coding/modulation. It has some or all functions of a base station.

Inter-satellite links (ISL): exists in the regenerative load scenario.

The relevant knowledge of the disclosure will be describe below before introducing technical solutions of the disclosure.

### New Radio (NR) Uplink Timing Advance:

An important feature of uplink transmission is that different terminals have orthogonal multiple access in time and frequency, that is, uplink transmission of different terminals from a same cell does not interfere with each other.

In order to ensure the orthogonality of uplink transmission and avoid intra-cell interference, a network device requires that the timings of signals from different terminals, which are at the same time but with different frequency domain resources, arriving at the network device are basically aligned.

In order to ensure time synchronization on the network device side, NR supports the mechanism of uplink timing advance.

The uplink clock and the downlink clock on the network device side are identical, while there is an offset between the uplink clock and the downlink clock on the terminal side. Different terminals have different amounts of uplink timing advance, respectively.

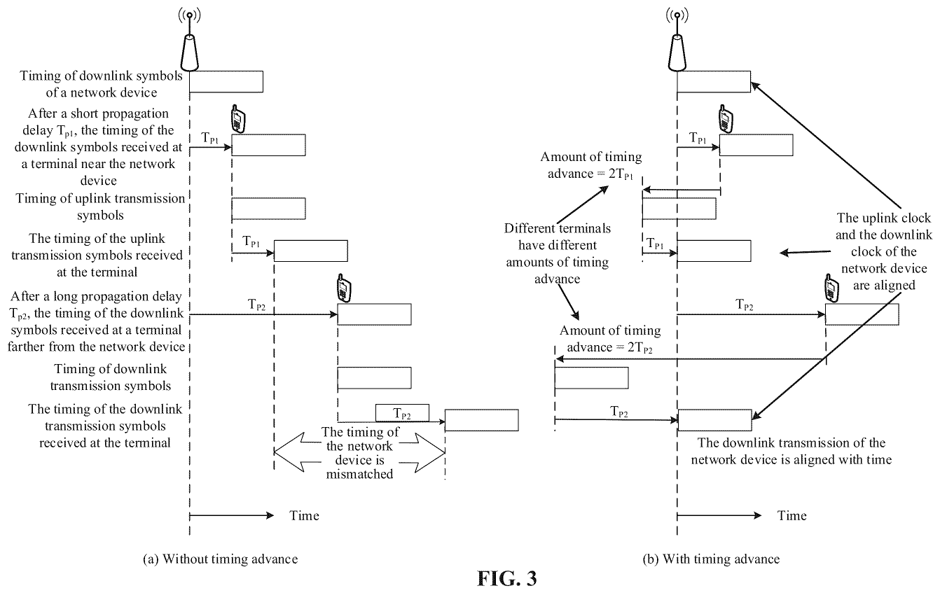

FIG. 3 illustrates a schematic diagram of time synchronization on the network device side provided in an exemplary embodiment of the disclosure. Here, (a) of FIG. 3 is a schematic diagram of time synchronization without timing advance, and (b) of FIG. 3 is a schematic diagram of time synchronization with timing advance.

The network device can control the timing of uplink signal from different terminals arriving at the network device by properly controlling the offset of each terminal. For a terminal far away from the network device, it is necessary to transmit uplink data in advance than a terminal close to the network device due to the large transmission time-delay.

Schematically, the network device determines a value of TA for each terminal based on the measurement of uplink transmissions of the terminal. The network device transmits TA command to the terminal in the following two ways.
1) Acquisition of initial TA. In the random access process, the network device determines the value of TA by measuring the received random access preamble, and transmits it to the terminal through the TA command field of random access response (RAR).
2) Adjustment of radio resource control (RRC) connection state TA. During the random access process, the terminal and the network device have achieved uplink synchronization, but the timing of uplink signal arriving at the network device may change with time, so the terminal needs to constantly update its uplink timing advance to maintain uplink synchronization. If the TA of a certain terminal needs to be corrected, the network device will transmit a TA command to the terminal and ask it to adjust the uplink timing. Schematically, the TA command is transmitted to the terminal through a media access control control element (MAC CE) corresponding to the TA command.

In a carrier aggregation (CA) scenario, the terminal may need to use different TAs for different uplink carriers, so the concept of timing advance group (TAG) is introduced into the standard. The network configures up to 4 TAGS for each cell group of the terminal, and configures its associated TAG for each cell at the same time. Schematically, the terminal maintains TA separately for each TAG.

### TA Maintenance in Non-Terrestrial Network (NTN):

For a NR NTN terminal in RRC_IDLE state/RRC_INACTIVE state and RRC_CONNECTED state, the TA of which is determined by the following formula:

$${T}_{TA} = ( {N}_{TA} + {N}_{TA , terminal - specific} + {N}_{TA , common} + {N}_{TA , offset} ) \times {T}_{c} .$$

Here, ·N_{TA} is defined as 0 under the scenario of physical random access channel (PRACH), which can be updated by TA command in Message 2 (Msg2) or Message B (MsgB) and MAC CE corresponding to the TA command.
N_{TA,terminal-specific} is a time-delay of a service link estimated by the terminal itself and used for TA pre-compensation. Specifically, the terminal will get the position of the satellite based on the position information of global navigation satellite system (GNSS) acquired by itself in combination with ephemeris information of the satellite broadcast by the cell, so as to calculate the propagation time-delay of the service link from the terminal to the satellite.
N_{TA,common} is a common TA controlled by the network, including any timing deviation that the network deems necessary.
N_{TA,offset} is a fixed offset for calculating TA.
T_{c} is a unit of time.

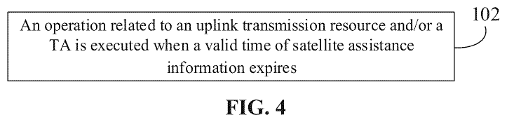

In view of the above, a method for information processing is provided in an embodiment of the disclosure, so as to define the behavior of a terminal when a valid time of satellite assistance information expires. FIG. 4 illustrates a flowchart of a method for information processing provided in an exemplary embodiment of the disclosure, the method is applied to a terminal and includes the following operation.

Operation 102: an operation related to an uplink transmission resource and/or a TA is executed when a valid time of satellite assistance information expires.

In the NTN system, the terminal determines information related to the uplink transmission resource and/or the TA based on the satellite assistance information. Alternatively, the satellite assistance information includes one or more of ephemeris information or a common TA.

The ephemeris information and the common TA are broadcast through system messages of cells.

There is a possibility of timing update of ephemeris information, such as timing update of position, moving direction, moving speed of the satellite and so on. In order to enable the terminal to correctly use the position of the satellite for TA compensation, the terminal needs to use effective ephemeris information for calculation.

The common TA is the propagation time-delay from reference point (RP) broadcast by the network device to the satellite, which is used for providing TA pre-compensation for partial feed link. The uplink timing and downlink timing at the reference point are aligned, and the terminal needs to get a valid value of the common TA to calculate the TA used in the final uplink transmission.

Schematically, the valid time of satellite assistance information is configured by a network device.

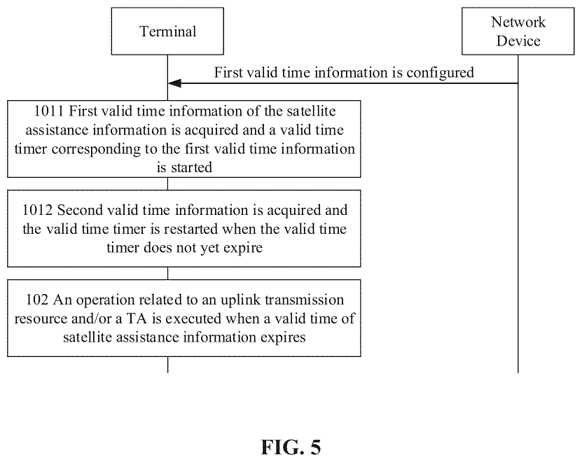

FIG. 5 illustrates a flowchart of a method for information processing provided in an exemplary embodiment of the disclosure based on FIG. 4, the method further includes the following operations.

Operation 1011: the terminal acquires first valid time information of the satellite assistance information configured by the network device and starting a valid time timer corresponding to the first valid time information.

Operation 1012: the terminal acquires second valid time information and restarts the valid time timer when the valid time timer does not yet expire.

Taking the valid time of the satellite assistance information is the first valid time as example, the network device configures the first valid time information for the terminal, and the terminal can use the satellite assistance information based on the first valid time information.

After acquiring the first valid time information, the terminal starts the corresponding valid time timer. Subsequently, when the valid time timer does not yet expire and the terminal acquires the second valid time information, the terminal restarts the valid time timer to time the usage duration of the second valid time information.

When the valid time timer expires, the valid time of the satellite assistance information expires, at which time the terminal needs to execute operation 102 to execute the operation related to the uplink transmission resource and/or the TA.

Taking the satellite assistance information includes the ephemeris information and the common TA as example.

For example, when the valid time of the ephemeris information and the common TA expire, the terminal releases all uplink transmission resource and releases cache information for all hybrid automatic retransmission requests (HARQ). Alternatively, the uplink transmission resource may include physical uplink control channel (PUCCH) resource.

For another example, when the valid time of the ephemeris information and the common TA expire, the terminal uses a TA command in a random access response (RAR). Alternatively, the TA command refers to a TA command of a timing advance group (TAG) where the terminal is located. The terminal acquires the TA command of the TAG where the terminal is located by listening to the Message B of the random access process. The terminal applies the TA command of the TAG where the terminal is located when a trigger reason of the random access process is that a valid time timer expires.

For another example, when the valid time of the ephemeris information and the common TA expire, the terminal triggers the random access process and stops a running timing alignment timer (TAT).

In summary, a method for information processing is provided in embodiments of the disclosure, when the valid time of the satellite assistance information expires, the behavior of the terminal is defined to cause it execute the operation related to the uplink transmission resource and/or the TA, so as to cause the terminal to determine the uplink transmission resource again and/or adjust the uplink TA.

According to the foregoing, when the valid time of the satellite assistance information expires, the terminal is defined in embodiments of the disclosure, which can perform any of the following three alternative implementations.

### 1. The Terminal Releases the Uplink Transmission Resource.

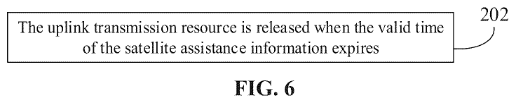

FIG. 6 illustrates a flowchart of a method for information processing provided in an exemplary embodiment of the disclosure, the method is applied to a terminal and includes the following operation.

Operation 202: the uplink transmission resource is released when the valid time of the satellite assistance information expires.

Alternatively, the satellite assistance information includes one or more of the ephemeris information or the common TA.

Alternatively, the method for information processing provided in an embodiment of the disclosure further includes: acquiring first valid time information of the satellite assistance information and starting a valid time timer corresponding to the first valid time information; and acquiring second valid time information and restarting the valid time timer when the valid time timer does not yet expire.

The description of the valid time of the satellite assistance information expires may refer to the above contents and will not be repeated here.

Alternatively, releasing the uplink transmission resource can be realized in at least one of the following.
Releasing all PUCCH resources.

Releasing all PUCCH resources can also be called emptying all PUCCH resources. Alternatively, when the valid time of the satellite assistance information expires, the terminal notifies the RRC layer to release all PUCCH resources.
Releasing all channel sounding reference signal (SRS) resources.

Releasing all SRS resources can also be called emptying all SRS resources. Alternatively, when the valid time of the satellite assistance information expires, the terminal notifies the RRC layer to release all SRS resources.
Releasing all semi-persistent scheduling (SPS) resources.

Schematically, the SPS resource is configured by the network device.

Releasing all SPS resources can also be called emptying all SPS resources. When the valid time of the satellite assistance information expires, the terminal notifies the RRC layer to release all configured SPS resources.
Releasing all configured grant (CG) resources.

Schematically, the CG resource is configured by the network device.

Releasing all CG resources can also be called emptying all CG resources. When the valid time of the satellite assistance information expires, the terminal notifies the RRC layer to release all configured CG resources.
Releasing all physical uplink shared channel (PUSCH) resources.

The PUSCH resource is used for semi-continuous channel state information (CSI) reporting. Releasing all PUSCH resources can also be called emptying all PUSCH resources.
Stopping using a first uplink transmission resource, which is configured before the valid time of the satellite assistance information expires, for uplink transmission.

The first uplink transmission resource includes one of: a PUSCH resource, a PUCCH resource and an SRS resource.

Alternatively, the method for information processing provided in an embodiment of the disclosure further includes the following operation.

The terminal releases cache information for a HARQ when the valid time of the satellite assistance information expires.

Releasing the cache information for the HARQ can also be called emptying the cache information for the HARQ.

It should be understood that the above operations can be used in any combination. For example, when the valid time of the satellite assistance information expires, the terminal releases the cache information for the HARQ and releases all SPS resources. Other combinations are similar and will not be repeated here.

In summary, the method for information processing provided in an embodiment of the disclosure releases the uplink transmission resource by the terminal, so that the terminal can reduce uplink interference after entering the uplink out-of-step state, which is beneficial for the network device to receive uplink data from other terminals.

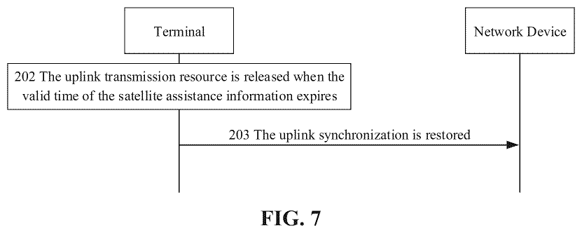

Alternatively, the terminal may further restore uplink synchronization with the network device after releasing the uplink transmission resource, so that the terminal can determine a new uplink transmission resource based on the configuration of the network device. FIG. 7 illustrates a flowchart of a method for information processing provided in an exemplary embodiment of the disclosure based on FIG. 6, the method for information processing provided in an embodiment of the disclosure further includes the following operation.

Operation 203: the terminal restores uplink synchronization with a network device.

Schematically, the terminal can restore uplink synchronization with the network device through a random access process.

For example, after receiving the handover command, the terminal reads NTN-system information blocks (NTN-SIB) again to initiate a random access, and restores uplink synchronization with the network device through the random access process.

After the terminal restores uplink synchronization with the network device, the terminal needs to determine a new uplink transmission resource again because the terminal has released the uplink transmission resource. Alternatively, an embodiment of the disclosure gives the following three ways to determine the new uplink transmission resource:
1. The terminal sends request information to the network device after restoring uplink synchronization with the network device.

Schematically, the request information is used to request for a second uplink transmission resource.

According to the foregoing, the first uplink transmission resource is an uplink transmission resource configured by the terminal before the valid time of the satellite assistance information expires, and the second uplink transmission resource is an uplink transmission resource requested by the terminal to the network device. Therefore, the second uplink transmission resource and the first uplink transmission resource are different uplink transmission resources.

Alternatively, the second uplink transmission resource includes at least one of:
a PUCCH resource;
an SRS resource;
an SPS resource;
an CG resource; or
a PUSCH resource.

Schematically, the terminal uses the first uplink transmission resource for uplink transmission before the valid time of the satellite assistance information expires. The terminal can release the first uplink transmission resource when the valid time of the satellite assistance information expires.

Subsequently, the terminal acquires a second uplink transmission resource by sending request to the network device after restoring uplink synchronization with the network device through the random access process. After determining the second uplink transmission resource, the terminal can use the second uplink transmission resource for uplink transmission.
2. The terminal receives RRC reconfiguration information from the network device after restoring uplink synchronization with the network device. The terminal uses the second uplink transmission resource for uplink transmission.

Schematically, the RRC reconfiguration information includes a second uplink transmission resource.

The second uplink transmission resource and the first uplink transmission resource are different uplink transmission resources.

Alternatively, the second uplink transmission resource includes at least one of: a PUCCH resource; an SRS resource; an SPS resource; a CG resource; or a PUSCH resource.

In summary, in the method for information processing provided in an embodiment of the disclosure, the terminal may restore uplink synchronization with the network device after releasing the uplink transmission resource.

Alternatively, the terminal may determine a new uplink transmission resource again for uplink transmission after restoring uplink synchronization with the network device. The new uplink transmission resource can be one of the first uplink transmission resource or the second uplink transmission resource.

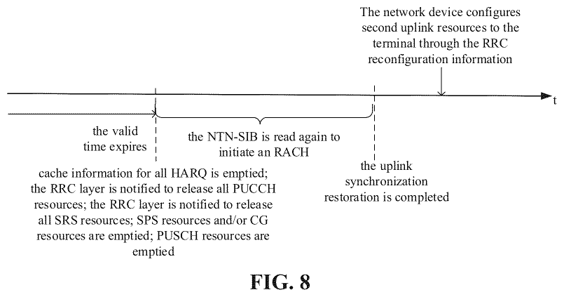

FIG. 8 illustrates a schematic diagram of an implementation of a method for information processing provided in an exemplary embodiment of the disclosure. In the figure:

When the valid time of the satellite assistance information expires, the terminal performs at least one of: emptying cache information for all HARQ; notifying the RRC layer to release all PUCCH resources; notifying the RRC layer to release all SRS resources; emptying SPS resources and/or CG resources; or emptying PUSCH resources for semi-continuous CSI reporting.

Subsequently, the terminal reads the NTN-SIB again to initiate a random access channel (RACH) application.

After completing the uplink synchronization restoration of the terminal and the network device, the terminal receives the RRC reconfiguration information configured by the network device, determines the second uplink transmission resource based on the RRC reconfiguration information, and uses the second uplink transmission resource for uplink transmission.
3. The terminal restores using the first uplink transmission resource, which is configured before the valid time of the satellite assistance information expires, for uplink transmission after restoring uplink synchronization with the network device.

According to the foregoing, the first uplink transmission resource includes one of: a PUSCH resource; a PUCCH resource; or a SRS resource.

Schematically, the terminal uses the first uplink transmission resource for uplink transmission before the valid time of the satellite assistance information expires. The terminal can release the first uplink transmission resource when the valid time of the satellite assistance information expires.

Subsequently, the terminal still uses the first uplink transmission resource for uplink transmission after restoring uplink synchronization with the network device through the random access process.

In summary, in the method for information processing provided in an embodiment of the disclosure, the uplink transmission resource is released by the terminal, so that the terminal can reduce uplink interference after entering the uplink out-of-step state, which is beneficial for the network device to receive uplink data from other terminals.

Alternatively, the terminal may restore uplink synchronization with the network device after releasing the uplink transmission resource.

Alternatively, the terminal may determine a new uplink transmission resource again for uplink transmission after restoring uplink synchronization with the network device. The new uplink transmission resource can be one of the first uplink transmission resource or the second uplink transmission resource.

### 2. The Terminal Uses the TA Command in the RAR.

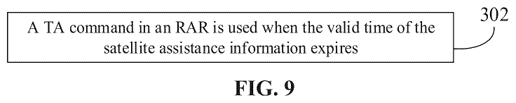

FIG. 9 illustrates a flowchart of a method for information processing provided in an exemplary embodiment of the disclosure, the method is applied to a terminal and includes the following operation.

Operation 302: a TA command in an RAR is used when the valid time of the satellite assistance information expires.

Alternatively, the satellite assistance information includes one or more of the ephemeris information or the common TA.

Alternatively, the method for information processing provided in an embodiment of the disclosure further includes: acquiring first valid time information of the satellite assistance information and starting a valid time timer corresponding to the first valid time information; and acquiring second valid time information and restarting the valid time timer when the valid time timer does not yet expire.

The description of the valid time of the satellite assistance information expires may refer to the above contents and will not be repeated here.

Alternatively, the TA command is carried in either Message 2 or Message B of a random access process.

Taking the TA command is carried in the Message 2 of the random access process as example, the method for information processing provided in an embodiment of the disclosure further includes: the terminal sends Message 1 of the random access process to the network device and listening to the Message 2 when the valid time of the satellite assistance information expires.

Alternatively, taking the TA command is carried in the Message B of the random access process as example, the method for information processing provided in an embodiment of the disclosure further includes: the terminal sends Message A of the random access process to the network device and listening to the Message B when the valid time of the satellite assistance information expires.

Alternatively, operation 302 can be realized as follows.

A TA command of a TAG where the terminal is located is received when the valid time of the satellite assistance information expires.

When a trigger reason of the random access process is that a valid time timer expires, the TA command of the TAG is applied, or a TAT corresponding to the TAG is started, or the TAT is restarted.

The valid time timer is a timer corresponding to the valid time of the satellite assistance information.

When a trigger reason of the random access process is that a valid time timer expires, the terminal applies the TA command of the TAG, so that the terminal can obtain the adjustment of the uplink TA by the network device; the terminal starts or restarts the TAT corresponding to the TAG, so that the terminal can restart the timing of the uplink transmission of the TAG where the terminal is located.

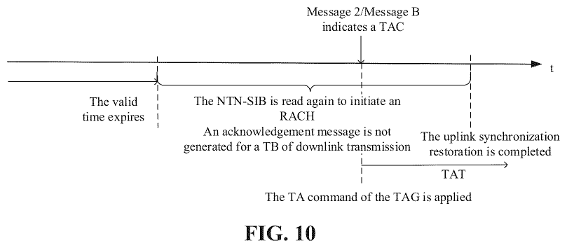

FIG. 10 illustrates a schematic diagram of an implementation of a method for information processing provided in an exemplary embodiment of the disclosure. In the figure:

The terminal reads the NTN-SIB again to initiate the RACH request when the valid time of the satellite assistance information expires. Alternatively, the terminal sends the Message 1 of the random access process to the network device and starts listening to the Message 2. Alternatively, the terminal sends the Message A of the random access process to the network device and starts listening to the Message B.

The Message 2 or the Message B is used to indicate a tracking area code (TAC).

Subsequently, the terminal determines the trigger reason of the random access process after receiving the TA command of the TAG where the terminal is located on the Message 2 or the Message B. The terminal applies the TA command of the TAG when the trigger reason of the random access process is that the valid time timer expires.

Alternatively, the TAT corresponding to the TAG where the terminal is located is in an operational state.

In the related art, when the TAT corresponding to the TAG where the terminal is located is in the operational state, which means that the uplink is in a synchronous state, the terminal will ignore the TA command in the Message 2 or the Message B during the random access process. In the method for information processing provided in an embodiment of the disclosure, the terminal will not ignore the Message 2 or the Message B, so that the terminal can still obtain the adjustment of the uplink TA by the network device under the condition that the uplink is in the synchronous state.

Alternatively, referring to FIG. 10, an acknowledgement message is not generated for a transport block (TB) of downlink transmission between a time point of the expiration of the valid time of the satellite assistance information and a time point of the success of the random access process.

The acknowledgement message includes a positive acknowledgement (ACK) and a negative acknowledgement (NACK), with the ACK indicating correct receipt and the NACK indicating incorrect receipt. For example, the MAC entity of the terminal does not instruct the physical layer not to generate an acknowledgement message NACK for the TB of downlink transmission.

Alternatively, the terminal may restore uplink synchronization with the network device when the valid time of the satellite assistance information expires. The related description of restoring uplink synchronization may refer to the above contents and will not be repeated here.

In summary, in the method for information processing provided in an embodiment of the disclosure, the TA command in the RAR is used by the terminal, so that the terminal obtains the adjustment of the uplink TA by the network device after entering the uplink out-of-step state.

Alternatively, when the TAT corresponding to the TAG where the terminal is located is in an operational state, by listening to the Message 2 or the Message B, the terminal may obtain the adjustment of the uplink TA by the network device through the TA command carried in the Message 2 or the Message B.

### 3. The Terminal Stops the Running TAT.

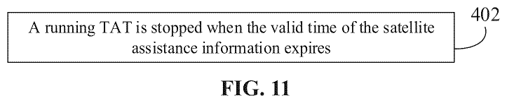

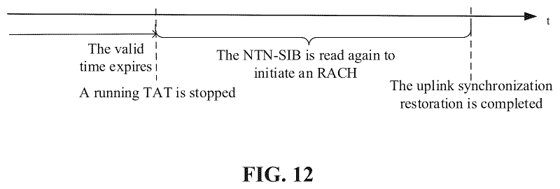

FIG. 11 illustrates a flowchart of a method for information processing provided in an exemplary embodiment of the disclosure. FIG. 12 illustrates a schematic diagram of an implementation of a method for information processing provided in an exemplary embodiment of the disclosure, which is applied to a terminal, including the following operation.

Operation 402: a running TAT is stopped when the valid time of the satellite assistance information expires.

Alternatively, the satellite assistance information includes one or more of the ephemeris information or the common TA.

Alternatively, the method for information processing provided in an embodiment of the disclosure further includes: acquiring first valid time information of the satellite assistance information and starting a valid time timer corresponding to the first valid time information; and acquiring second valid time information and restarting the valid time timer when the valid time timer does not yet expire.

The description of the valid time of the satellite assistance information expires may refer to the above contents and will not be repeated here.

Alternatively, operation 402 can be realized as follows.

A random access process is triggered to stop the TAT when the valid time of the satellite assistance information expires.

Alternatively, the TAT is stopped when the random access process is triggered due to the expiration of the valid time of the satellite assistance information.

Alternatively, referring to FIG. 12, the terminal may restore uplink synchronization with the network device when the valid time of the satellite assistance information expires. The related description of restoring uplink synchronization may refer to the above contents and will not be repeated here.

In the related art, when the TAT corresponding to the TAG where the terminal is located is in an operational state, it means that the uplink is in a synchronous state. In the method for information processing provided in an embodiment of the disclosure, the terminal stops the running TAT, so that the terminal may enter the uplink out-of-step state to perform subsequent operations.

It should be understood that the above mentioned multiple embodiments may be used in combination as actual needs and will not be repeated here. For example, the terminal stops the running TAT and uses the TA command in the RAR when the valid time of the satellite assistance information expires.

The following is the device embodiment of the disclosure. For details not described in detail in the device embodiment, reference can be made to the corresponding description in the above method embodiments, and will not be repeated here.

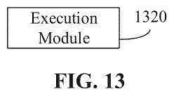

FIG. 13 illustrates a structural diagram of an apparatus for information processing provided in an exemplary embodiment of the disclosure, the device includes an execution module 1320.

The execution module 1320 is configured to execute an operation related to an uplink transmission resource and/or a timing advance (TA) when a valid time of satellite assistance information expires.

Alternatively, the execution module 1320 is configured to release the uplink transmission resource when the valid time of the satellite assistance information expires.

Alternatively, the execution module 1320 is configured to execute at least one of: releasing all physical uplink control channel (PUCCH) resources; releasing all channel sounding reference signal (SRS) resources; releasing all semi-persistent scheduling (SPS) resources; releasing all configured grant (CG) resources; releasing all physical uplink shared channel (PUSCH) resources; or stopping using a first uplink transmission resource, which is configured before the valid time of the satellite assistance information expires, for uplink transmission.

Alternatively, the execution module 1320 is configured to release cache information for a hybrid automatic retransmission request (HARQ).

Alternatively, the execution module 1320 is configured to restore uplink synchronization with a network device through a random access process.

Alternatively, the execution module 1320 is configured to send request information to the network device after restoring uplink synchronization with the network device, and the request information is used to request for a second uplink transmission resource.

Alternatively, the execution module 1320 is configured to receive radio resource control (RRC) reconfiguration information from the network device after restoring uplink synchronization with the network device, and the RRC reconfiguration information includes a second uplink transmission resource.

The terminal uses the second uplink transmission resource for uplink transmission.

Alternatively, the second uplink transmission resource includes at least one of: a PUCCH resource; an SRS resource; an SPS resource; a CG resource; or a PUSCH resource.

Alternatively, the execution module 1320 is further configured to restore using a first uplink transmission resource, which is configured before the valid time of the satellite assistance information expires, for uplink transmission after restoring uplink synchronization with the network device.

Alternatively, the first uplink transmission resource comprises one of: a PUSCH resource; a PUCCH resource; or a SRS resource.

Alternatively, the execution module 1320 is configured to use a TA command in a random access response (RAR) when the valid time of the satellite assistance information expires.

Alternatively, the TA command is carried in either Message 2 or Message B of a random access process.

Alternatively, the execution module 1320 is further configured to send Message 1 of the random access process to a network device and listening to the Message 2 when the valid time of the satellite assistance information expires. Alternatively, the execution module 1320 is further configured to send Message A of the random access process to the network device and listening to the Message B when the valid time of the satellite assistance information expires.

Alternatively, the execution module 1320 is further configured to: receive a TA command of a timing advance group (TAG) where the terminal is located; and when a trigger reason of the random access process is that a valid time timer expires, apply the TA command of the TAG, or start a timing alignment timer (TAT) corresponding to the TAG, or restart the TAT.

Alternatively, an acknowledgement message is not generated for a transport block TB of downlink transmission between a time point of the expiration of the valid time of the satellite assistance information and a time point of the success of the random access process.

Alternatively, a timing alignment timer (TAT) corresponding to a timing advance group (TAG) where the terminal is located is in an operational state.

Alternatively, the execution module 1320 is configured to stop a running timing alignment timer (TAT) when the valid time of the satellite assistance information expires.

Alternatively, the execution module 1320 is configured to trigger a random access process to stop the TAT when the valid time of the satellite assistance information expires; or stop the TAT when the random access process is triggered due to the expiration of the valid time of the satellite assistance information.

Alternatively, the satellite assistance information includes one or more of ephemeris information and a common timing advance (TA).

Alternatively, the execution module 1320 is further configured to: acquire first valid time information of the satellite assistance information and start a valid time timer corresponding to the first valid time information; and acquire second valid time information and restart the valid time timer when the valid time timer does not yet expire.

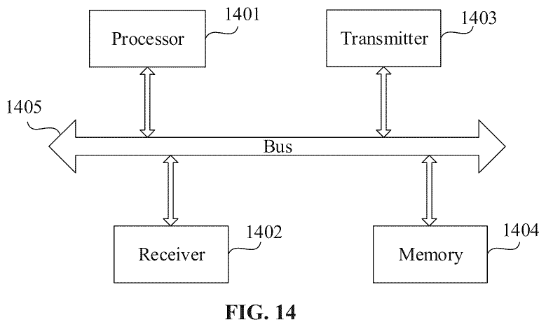

FIG. 14 illustrates a schematic structural diagram of a communication device (a terminal or a network device) provided in an exemplary embodiment of the disclosure. The communication device includes: a processor 1401, a receiver 1402, a transmitter 1403, a memory 1404, and a bus 1405.

The processor 1401 includes one or more processing cores and executes various functional applications and information processing by running software programs and modules.

The receiver 1402 and the transmitter 1403 may be implemented as a communication component which may be a communication chip.

The memory 1404 is connected to the processor 1401 via the bus 1405.

The memory 1404 may be operable to store at least one instruction, and the processor 1401 may be operable to execute the at least one instruction to implement various operations of the method for determining RAR receiving window mentioned in the above method embodiments.

In addition, the memory 1404 may be implemented by any type of volatile or non-volatile storage device or a combination thereof, including but not limited to: magnetic disk or optical disk, electrically erasable programmable read only memory (EEPROM), erasable programmable read only memory (EPROM), static random access memory (SRAM), read only memory (ROM), magnetic memory, flash memory, programmable read only memory (PROM).

The embodiment of the disclosure also provides a terminal, including a processor. The processor is configured to execute an operation related to an uplink transmission resource and/or a timing advance (TA) when a valid time of satellite assistance information expires.

The embodiment of the disclosure also provides a network device, including a processor. The processor is configured to execute an operation related to an uplink transmission resource and/or a timing advance (TA) when a valid time of satellite assistance information expires.

The embodiment of the disclosure also provides a computer-readable storage medium, having stored therein a computer program, which being executed by a processor to implement the method for information processing described above.

The embodiment of the disclosure also provides a chip, including a programmable logic circuit and/or program instructions for implementing the method for information processing described above when the chip is running.

The embodiment of the disclosure also provides a computer program product or computer program, including computer instructions stored in a computer-readable storage medium, from which a processor reads and executes the computer instructions to implement the method for information processing described above.

The above are only optional embodiments of the disclosure, and are not intended to limit the disclosure. Any modification, equivalent replacement, improvement, etc. made within the spirit and principle of the disclosure shall be included in the scope of protection of the disclosure.

1. A method for information processing, applied to a terminal, the method comprising:
executing an operation related to an uplink transmission resource and/or a timing advance (TA), when a valid time of satellite assistance information expires.

2. The method of claim 1, wherein executing the operation related to the uplink transmission resource and/or the TA when the valid time of the satellite assistance information expires, comprises:
releasing the uplink transmission resource, when the valid time of the satellite assistance information expires.

3. The method of claim 2, wherein releasing the uplink transmission resource comprises at least one of:
releasing all physical uplink control channel (PUCCH) resources;
releasing all channel sounding reference signal (SRS) resources;
releasing all semi-persistent scheduling (SPS) resources;
releasing all configured grant (CG) resources;
releasing all physical uplink shared channel (PUSCH) resources; or
stopping using a first uplink transmission resource, which is configured before the valid time of the satellite assistance information expires, for uplink transmission.

4. The method of claim 2, further comprising:
releasing cache information for a hybrid automatic retransmission request (HARQ).

5. The method of claim 2, further comprising:
restoring uplink synchronization with a network device through a random access process.

6. The method of claim 5, further comprising:
after restoring uplink synchronization with the network device, restoring using a first uplink transmission resource, which is configured before the valid time of the satellite assistance information expires, for uplink transmission.

7. The method of claim 3, wherein the first uplink transmission resource comprises one of:
a PUSCH resource;
a PUCCH resource; or
a SRS resource.

8. An apparatus for information processing, comprising:
a processor configured to execute an operation related to an uplink transmission resource and/or a timing advance (TA), when a valid time of satellite assistance information expires.

9. The apparatus of claim 8, wherein
the processor is configured to release the uplink transmission resource, when the valid time of the satellite assistance information expires.

10. The apparatus of claim 9, wherein the processor is configured to execute at least one of:
releasing all physical uplink control channel (PUCCH) resources;
releasing all channel sounding reference signal (SRS) resources;
releasing all semi-persistent scheduling (SPS) resources;
releasing all configured grant (CG) resources;
releasing all physical uplink shared channel (PUSCH) resources; or
stopping using a first uplink transmission resource, which is configured before the valid time of the satellite assistance information expires, for uplink transmission.

11. The apparatus of claim 9, wherein
the processor is further configured to release cache information for a hybrid automatic retransmission request (HARQ).

12. The apparatus of claim 9, wherein
the processor is further configured to restore uplink synchronization with a network device through a random access process.

13. The apparatus of claim 12, wherein
the processor is further configured to restore using a first uplink transmission resource, which configured before the valid time of the satellite assistance information expires, for uplink transmission after restoring uplink synchronization with the network device.

14. The apparatus of claim 10, wherein the first uplink transmission resource comprises one of:
a physical uplink shared channel (PUSCH) resource;
a physical uplink control channel (PUCCH) resource; or
a channel sounding reference signal (SRS) resource.

15. A network device, comprising:
a processor for configuring a first valid time information for a terminal device, such that the terminal device executes an operation related to an uplink transmission resource and/or a timing advance (TA), when the valid time of satellite assistance information expires.

16. The network device of claim 15, wherein the processor is configured to:
send a first valid time information to the terminal device, such that the terminal device releases the uplink transmission resource, when the valid time of the satellite assistance information expires.

17. The network device of claim 16, wherein the uplink transmission resource comprises at least one of:
all physical uplink control channel (PUCCH) resources;
all channel sounding reference signal (SRS) resources;
all semi-persistent scheduling (SPS) resources;
all configured grant (CG) resources;
all physical uplink shared channel (PUSCH) resources; or
a first uplink transmission resource, which is configured before the valid time of the satellite assistance information expires, for uplink transmission.

18. The network device of claim 16, further comprising:
receiving request information from the terminal device after the terminal device restores uplink synchronization with the network device, wherein the request information is used by the terminal device to request for a second uplink transmission resource.

19. The network device of claim 16, further comprising:
sending radio resource control (RRC) reconfiguration information to the terminal device after the terminal device restores uplink synchronization, wherein the RRC reconfiguration information comprises a second uplink transmission resource,
wherein the second uplink transmission resource is used by the terminal device for uplink transmission.

20. The network device of claim 17, wherein the first uplink transmission resource comprises one of:
a PUSCH resource;
a PUCCH resource; or
a SRS resource.
